(19) United States
(12) Patent Application Publication
(10) Pub. No.: US 2018/0048827 A1
(43) Pub. Date: Feb. 15, 2018

(54) Method for capturing a video, related computer program and electronic system for capturing a video

(71) Applicant: PARROT DRONES, Paris (FR)

(72) Inventors: Henri Seydoux, Paris (FR); Frédéric Pirat, Paris (FR); Mathieu Babel, Paris (FR)

(21) Appl. No.: 15/672,692

(22) Filed: Aug. 9, 2017

(30) Foreign Application Priority Data
Aug. 11, 2016 (FR) 16 57727

(51) Int. Cl. H04N 5/232; G01C 17/10; B64D 47/08; G05D 1/00; H04N 7/18; B64C 39/02

(52) U.S. Cl. CPC H04N 5/23296; H04N 7/183; B64C 39/024; B64D 47/08; G05D 1/0038; G01C 17/10; B64C 2201/021; B64C 2201/141; B64C 2201/146

(57) ABSTRACT

The invention relates to a method for capturing a video using a camera on board a fixed-wing drone, the camera comprising an image sensor, the drone having, during flight, a drift angle between the longitudinal axis of the drone and a flight direction of the drone. This method comprises: determining the drift angle of the drone; and obtaining video by image acquisition corresponding to a zone with reduced dimensions relative to those of the image sensor, the position of the zone being determined as a function of the drift angle of the drone.

This application claims priority from French Patent Application No. 16 57727 filed on Aug. 11, 2016. The content of this application is incorporated herein by reference in its entirety.

### BACKGROUND

The present invention relates to a method for capturing a video using a camera on board a drone with fixed wings, the camera comprising an image sensor, the drone having, during flight, a drift angle between the longitudinal axis of the drone and a flight direction of the drone.

In particular, the fixed-wing drone is of the “sailwing” type. Hereinafter, a “drone” refers to an aircraft with no pilot on board. A drone is autonomous, piloted by automatic pilot in autonomous flight, or piloted remotely assisted by the automatic pilot, in particular using a control stick. The invention also relates to a computer program including software instructions which, when executed by a computer, carry out such a method for capturing a video.

The invention also relates to an electronic system for capturing a video comprising a fixed-wing drone, the camera comprising an image sensor on board the drone, the drone having, during flight, a drift angle between the longitudinal axis of the drone and a flight direction of the drone.

It is possible to provide a drone with equipment for performing specific tasks. It is in particular possible to equip the drone with a camera having an image sensor, to take videos.

Traditionally, the direction in which the camera is pointed corresponds to the longitudinal axis of the drone. In other words, in the absence of wind, the direction targeted by the camera on board the drone corresponds to the direction of flight.

Under the effect of the crosswind, a lateral force is applied on the body of the drone (fuselage). To compensate this lateral force due to the wind and prevent the drone from moving away from its route, the user, or the automatic pilot in autonomous flight, must cause a drift angle between the longitudinal axis of the drone and its direction of flight. The viewing direction of the camera is then shifted by the drift angle relative to the direction of flight of the drone.

In another case, when a gust of wind occurs, the user or the automatic pilot does not have time to compensate the lateral force due to the gust, and the longitudinal axis of the drone and its direction of flight are shifted by a drift angle. The viewing direction of the camera is then shifted relative to the direction of flight of the drone.

Thus, when the fixed-wing drone has drifted under the effect of the wind or the compensation for the wind, the viewing axis of the camera is no longer situated in the axis of the actual direction of flight of the drone.

Such a drift between the longitudinal axis of the drone and its direction of flight deteriorates the piloting capacities of the user, who, in the “immersive piloting” configuration, cannot determine the trajectory of flight of the drone he is piloting, and if applicable correct its piloting to reach the targeted destination.

Such a lack of knowledge of the trajectory of the drone in the presence of wind is also problematic due to the fact that obstacles are sometimes present on this actual flight trajectory of the drone.

As a result, when the fixed-wing drone is outside the visual range of the user, or when the user essentially bases his piloting on the real-time playback of images filmed by the camera, such obstacles will not be able to be avoided, which will result in an interruption of the flight and filming, or even a deterioration of the fixed-wing drone in case of impact with the obstacle or crash.

One aim of the invention is then to propose a method for capturing a video using a camera on board a fixed-wing drone, the camera comprising an image sensor allowing the user to optimize his piloting in the presence of wind.

To that end, the invention relates to a method for capturing a video using a camera on board a drone with fixed wings, the camera comprising an image sensor, the drone having, during flight, a drift angle between the longitudinal axis of the drone and a flight direction of the drone, the method comprising:

determining the drift angle of the drone; and

obtaining video by image acquisition corresponding to a zone with reduced dimensions relative to those of the image sensor, the position of the zone being determined as a function of the drift angle of the drone.

The method for capturing a video according to the invention makes it possible to keep the axis of the video obtained using the camera on board a fixed-wing drone in the direction of flight, and not in the direction of the longitudinal axis of the fixed-wing drone.

In other words, the method according to the invention allows an instantaneous virtual adjustment of the direction targeted by the camera on board the fixed-wing drone based on the intensity of the crosswind.

Furthermore, the user directly perceives the effect of the crosswind on the actual trajectory of the drone through the image he is viewing and, if necessary, corrects his piloting so as to compensate for the effect of drift caused by the wind in order to reach the targeted flight destination and avoid obstacles on this actual trajectory.

According to other advantageous aspects of the invention, the video capture method comprises one or more of the following features, considered alone or according to all technically possible combinations:

the camera comprises a fisheye lens associated with the image sensor,

the zone, the position of which is determined as a function of the drift angle, is configured to capture a region of the scene filmed by the image sensor on board the drone along a viewing direction parallel to the direction of flight of the drone,

the zone, the position of which is determined as a function of the drift angle (α), and the zone obtained in the absence of drift of the drone have a non-zero intersection,

the position of the zone is calculated such that the window corresponding to the overall field of the camera rotates, relative to that without drift, by a drift angle α of the drone around the yaw axis of the drone,

the determination of the drift angle comprises:
the determination of the angle between the longitudinal axis of the drone and magnetic north,
the determination of the drift angle as a function of:
the angle between the longitudinal axis of the drone and magnetic north, and
the direction of flight of the drone,

obtaining video comprises acquiring image data from the entire surface area of the image sensor, followed by digital processing of the image data delivering video images corresponding solely to the zone,

the acquisition of image data only in the zone during the production of the video, the position of the zone being determined during the production of the video,

when the zone, the position of which is determined as a function of the drift angle, abuts with the image sensor, the image corresponding to the zone comprises a black area,

when the zone, the position of which is determined as a function of the drift angle, abuts with the image sensor, the position is reset such that the center of the zone is on the longitudinal axis of the fixed-wing drone.

The invention also relates to a computer program comprising software set points which, when executed by a computer, carry out a method as defined above.

The invention also relates to an electronic system for capturing a video comprising a fixed-wing drone and a camera on board the fixed-wing drone, the camera comprising an image sensor, the drone having, during flight, a drift angle between the longitudinal axis of the drone and a flight direction of the drone, the electronic system for capturing a video further comprising:

a determining module configured to determine the drift angle of the drone; and

an obtaining module configured to obtain the video by acquiring at least one image corresponding to a zone with reduced dimensions relative to those of the image sensor, the obtaining module being configured to determine the position of the zone as a function of the drift angle of the drone.

These features and advantages of the invention will appear more clearly upon reading the following description, provided solely as a non-limiting example, and done in reference to the appended drawings, in which:

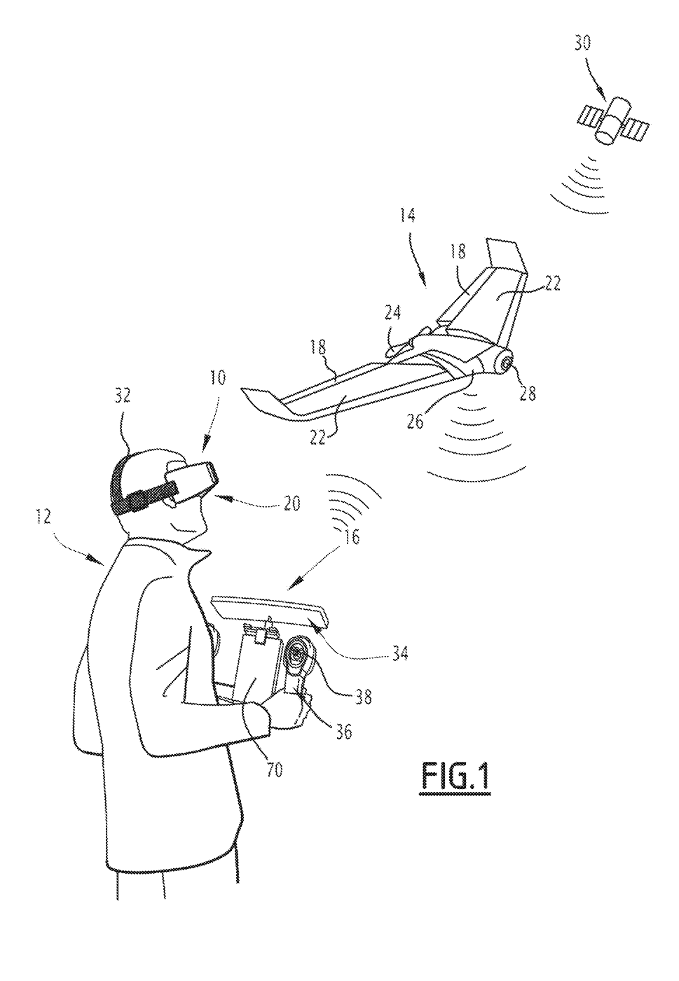

FIG. 1 is a perspective view of an electronic video capture system according to the invention, comprising a fixed-wing drone of the sailwing type, moving through the air under the control of remote control equipment;

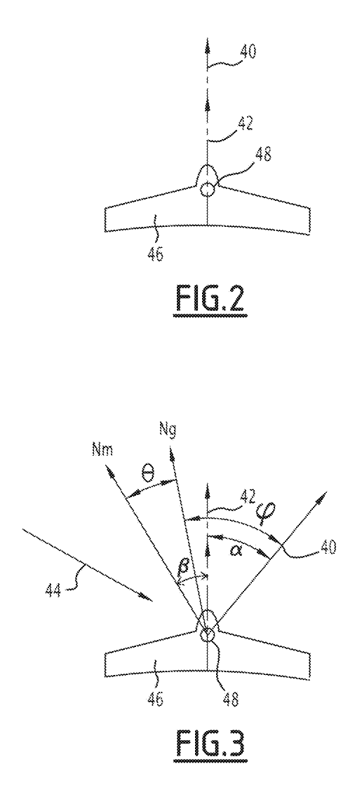

FIG. 2 is a schematic illustration of the direction of flight of the fixed-wing drone without wind;

FIG. 3 is a schematic illustration of the direction of flight of the fixed-wing drone with wind;

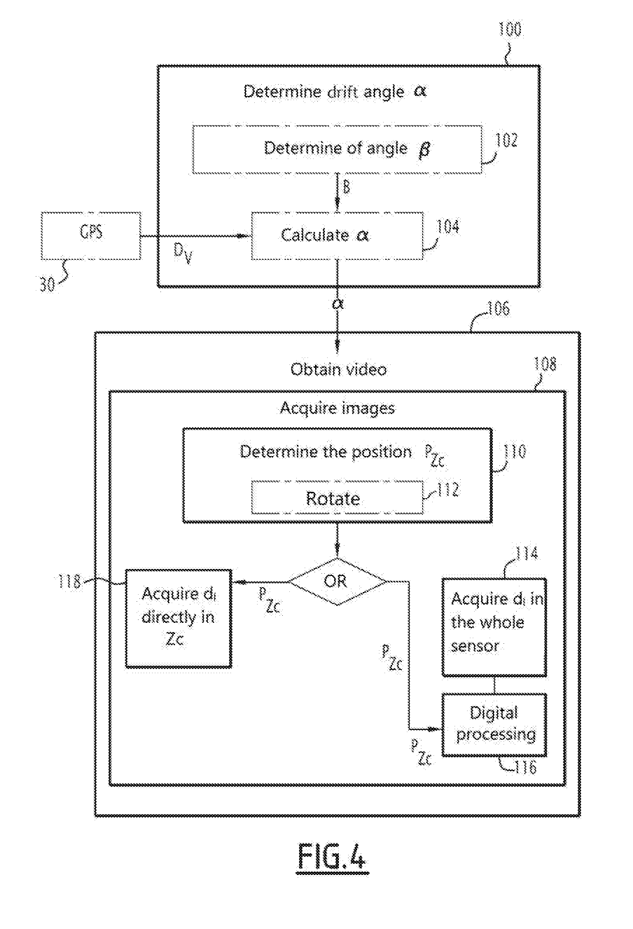

FIG. 4 is a flowchart of a method for capturing a video according to the invention;

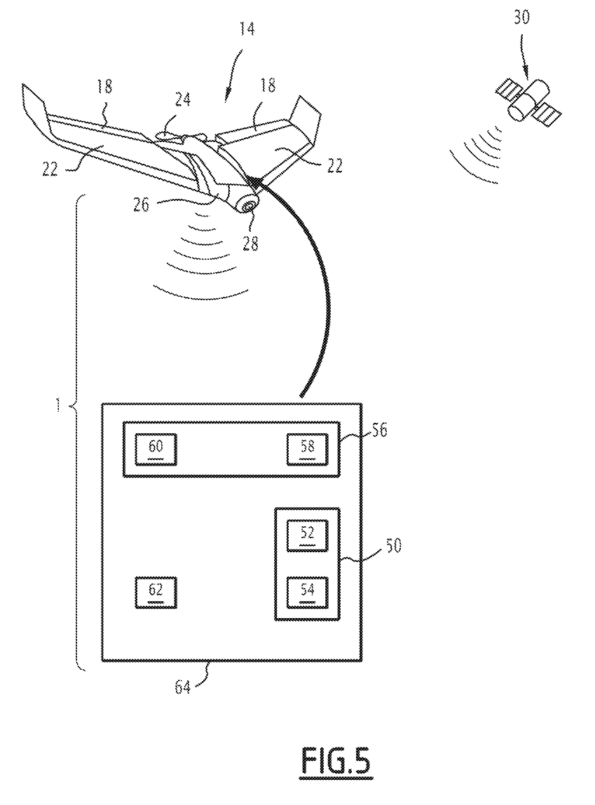

FIG. 5 is a partial schematic illustration of the modules making up the electronic system for capturing a video according to the invention; and

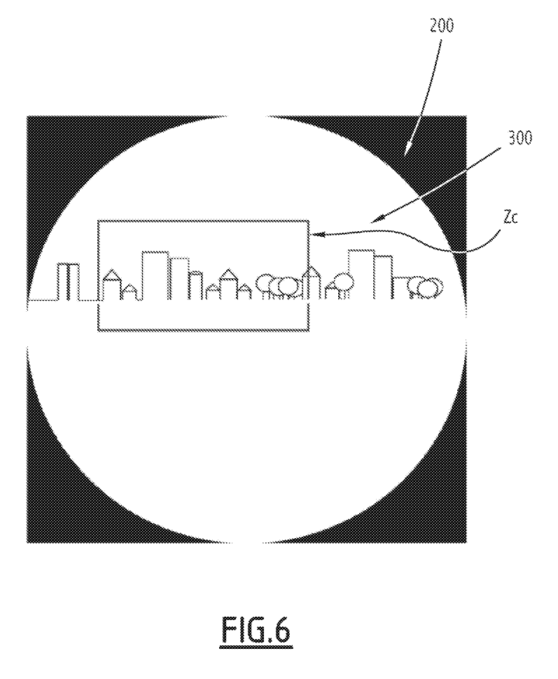

FIG. 6 is a schematic illustration of images respectively corresponding to the overall field of the camera obtained on the image sensor, the projection of the image obtained by the lens associated with the image sensor, and the zone whose position is determined according to the invention.

In FIGS. 1 and 5, an electronic video capture system 1 allows a user 12 to optimize the piloting of a drone 14, in particular a fixed-wing drone, particularly of the “sailwing” type.

The fixed-wing drone 14 comprises a drone body (fuselage) 26 provided in the rear part with a propeller 24 and on the sides with two wings 22, these wings extending the drone body 26 in the illustrated configuration of the “sailwing” type. On the side of the trailing edge, the wings 22 are provided with control surfaces 18 able to be oriented using servo mechanisms to control the path of the drone.

The drone 14 is also provided with a camera fastened on the fixed-wing drone 14 (i.e., no movement of the camera is possible). The camera having an image sensor 28 configured to acquire at least one image of a scene, and a transmission module, not shown, configured to send the image(s) acquired by the image sensor 28, preferably wirelessly, to a piece of electronic equipment, such as the reception module, not shown, of the electronic viewing system 10, the reception module, not shown, of the control stick 16, or the reception module of the multimedia touchscreen digital tablet 70 mounted on the control stick 16, not shown.

The image sensor 28 is for example associated with a hemispherical lens of the fisheye type, i.e., covering a viewing field with a wide angle, of about 180° or more. The projection 300 of the image obtained by the fisheye lens associated with the image sensor 28 is shown in FIG. 6. The camera comprises the image sensor 28 and the lens positioned in front of the image sensor 28 such that the image sensor detects the images through the lens.

In the example of FIG. 5, the fixed-wing drone 14 further comprises an information processing unit 50, for example formed by a memory 52 and a processor 54 associated with the memory 52.

The fixed-wing drone 14 also comprises a determining module 56 configured to determine the drift angle α of the drone. The drift angle α corresponds to the angle formed, during flight and in the presence of cross wind 44, between a longitudinal axis 42 of the drone and a direction of flight 40 of the drone, as shown in FIG. 3.

In the example of FIG. 5, the determination module 56 determining the drift angle α of the drone comprises a determining module 58, for example a magnetometer, configured to determine the angle β between the longitudinal axis 42 of the fixed-wing drone 14 and magnetic north, as shown in FIG. 3.

The determination module 56 for determining the drift angle α of the drone also comprises a module 60 for determining the direction of flight 40 of the fixed wing drone 14, for example a geolocation module receiving, in real time from a constellation of geolocation satellites 30, the information allowing the determination module 60 to determine the instantaneous geographical position of the fixed-wing drone 14 and to calculate the direction of flight 40 of the fixed-wing drone 14. The direction of flight 40 of the fixed wing drone 14 is expressed by the angle φ between geographical north and the geographical position of the fixed-wing drone 14, as shown in FIG. 3. The geolocation module for example uses the GPS or Galileo geolocation system.

From the angle β between the longitudinal axis 42 of the fixed-wing drone 14 and magnetic north, delivered by the magnetometer 58, the magnetic breakdown θ corresponding to the angle formed between the direction of the geographical north pole and magnetic north, as shown in FIG. 3, and the angle φ representative of the direction of flight 40 delivered by the module 60 determining the direction of flight 40, the module 56 for determining the drift angle α is configured to calculate the drift angle α.

For example, according to the illustration of FIG. 3, the drift angle α is such that: |α|=|φ|−|β|+|θ|.

The fixed-wing drone 14 also comprises an obtaining module 62 configured to obtain the video by acquiring at least one image using the image sensor 28, the image corresponding to a zone Zc of the image sensor 28, with reduced dimensions relative to those of the image sensor, the position of the zone Zc being determined as a function of the drift angle α of the fixed-wing drone 14.

The image sensor 28 is the photosensitive member of the camera. It is for example a CMOS sensor. The zone Zc is a fraction of the image sensor 28.

The image sensor 28 associated with the lens is able to provide an overall image corresponding to an overall field 200 of the camera as shown in FIG. 6. The zone Zc of the image sensor 28 corresponds to a window of the overall field with smaller dimensions relative to those of the overall field. The acquired image corresponding to the zone Zc is the image that would be acquired by this zone Zc without using the rest of the image sensor.

Obtaining an image from a zone Zc with smaller dimensions of the image sensor makes it possible to virtually orient the viewing axis of the camera in the direction of the window of the overall field of the camera corresponding to the zone Zc with smaller dimensions, without modifying the physical orientation of the camera, which remains immobile relative to the fixed-wing drone 14.

According to a first alternative, the obtaining module 62 comprises a module for acquiring image data dₗ, not shown, configured to acquire image data from the entire surface area of the image sensor, and a digital processing module for the image data, not shown, configured to deliver video images corresponding only to the zone Zc, the position of the zone Zc being determined as a function of the drift angle α of the fixed-wing drone 14. The output of the acquisition module is connected to the input of the digital processing module.

According to a second alternative, the obtaining module 62 comprises only a module for acquiring image data, not shown, configured to acquire image data only in the zone Zc during the video production, the position of the zone Zc being determined as a function of the drift angle α of the fixed-wing drone 14.

In the example of FIG. 5, the module 56 for determining the drift angle α of the fixed-wing drone 14 and the obtaining module 62 configured to obtain the video are each made so as to comprise software executable by the processor 54. The memory 52 of the information processing unit 50 is then able to store determining software configured to determine the drift angle α of the fixed-wing drone 14, and obtaining software configured to obtain the video by acquiring at least one image corresponding to a zone Zc with reduced dimensions relative to those of the image sensor 28, the position of the zone Zc being determined as a function of the drift angle α of the fixed-wing drone 14.

The processor 54 of the information processing unit 50 is then able to execute the determining software and the obtaining software using a computer program.

Alternatively, the module 56 for determining the drift angle α of the fixed-wing drone 14 and the obtaining module 62 configured to obtain the video are each made in the form of a programmable logic component, such as an FPGA (Field Programmable Gate Array), or in the form of a dedicated integrated circuit, such as an ASIC (Application Specific Integrated Circuit) mounted on an electronic board 64 on board the fixed-wing drone 14.

An electronic viewing system 10 allows the user 12 to view images, in particular images of the video received from the fixed-wing drone 14.

The electronic viewing system 10 comprises an electronic device, for example a smartphone, provided with a display screen, and a headset 20 including a reception support of the electronic device, a bearing surface against the face of the user 12, across from the user's eyes, and two optical devices positioned between the reception support and the bearing surface.

The headset 20 further includes a maintaining strap 32 making it possible to maintain the headset 20 on the head of the user 12.

The electronic device is removable with respect to the headset 20 or integrated into the headset 20.

The electronic viewing system 10 is for example connected to a control stick 16 via a data link, not shown, the data link being a wireless link or a wired link.

In the example of FIG. 1, the electronic viewing system 10 further comprises a reception module, not shown, configured to receive at least one image from the fixed-wing drone 14, the transmission of the image preferably being done wirelessly.

The viewing system 10 is for example a virtual-reality viewing system, i.e., a system allowing the user 12 to view an image in his field of view, with a field of view (or field of vision, FOV) angle with a large value, typically greater than 90°, preferably greater than or equal to 100°, in order to procure an immersive view (also called “FPV”, First Person View) for the user 12.

The control stick 16 is known in itself, and for example makes it possible to pilot the fixed-wing drone 14. The control stick 16 comprises two gripping handles 36, each being intended to be grasped by a respective hand of the user 12, a plurality of control members, here including two joysticks 38, each being positioned near a respective gripping handle 36 and being intended to be actuated by the user 12, preferably by a respective thumb.

The control stick 16 also comprises a radio antenna 34 and a radio transceiver, not shown, for exchanging data by radio waves with the fixed-wing drone 14, both uplink and downlink.

Additionally, or alternatively in light of the viewing system 10, a digital multimedia touchscreen tablet 70 is mounted on the control stick 16 to assist the user 12 during piloting of the fixed-wing drone 14.

The operation of the electronic system for capturing a video 1 according to the invention will now be described using FIG. 4, showing a flowchart of the method for capturing a video, implemented by a computer.

The method for capturing a video according to the invention allows the virtual orientation of the viewing axis of the camera, and therefore the direction filmed by the drone when the fixed-wing drone 14 experiences wind 44.

When the image sensor 28 is associated with a fisheye lens, it is possible to orient the viewing axis of the camera virtually with a sufficient angular travel, in particular to account for the drift of the fixed-wing drone 14.

In particular, the method for capturing a video according to the invention makes it possible to define a virtual image sensor by selecting a zone Zc with smaller dimensions relative to the actual dimensions of the image sensor 28.

In FIG. 6, the images respectively corresponding to the overall field 200 of the camera obtained on the image sensor 28, the projection 300 of the image obtained by the lens associated with the image sensor, and the zone Zc whose position is determined according to the invention, are respectively shown.

During a step 100, the drift angle α of the fixed-wing drone 14 is determined by the determining module 56.

According to the embodiment shown in FIG. 4, the step 100 for determining the drift angle α comprises a step 102 for determining the angle β between the longitudinal axis 42 of the drone and magnetic north implemented by the magnetometer 58.

Furthermore, according to the embodiment shown in FIG. 4, the step 100 for determining the drift angle α comprises a step 104 for calculating the drift angle α from the angle β between the longitudinal axis 42 of the fixed-wing drone 14 and magnetic north, delivered by the magnetometer 58, the magnetic breakdown θ corresponding to the angle formed between the direction of the geographical north pole and magnetic north, as shown in FIG. 3, and the angle φ representative of the direction of flight 40 delivered by the GPS module 60 receiving, in real time from a GPS satellite 30, the heading information representative of the direction of flight 40 of the fixed-wing drone 14.

During a step 106, the video filmed during flight by the fixed-wing drone 14 is obtained.

More specifically, the step for obtaining the video 106 comprises an image acquisition step 108.

When the lens associated with the image sensor 28 is of the fisheye type, the image acquisition step 108 in particular carries out a correction, not shown, of the geometric distortions introduced by the image sensor 28.

The image acquisition step 108 comprises a step 110 for determining the position P_{zc} of the zone Zc with reduced dimensions relative to the actual dimensions of the image sensor 28 as a function of the drift angle α of the fixed-wing drone 14.

According to a first alternative, the zone Zc, the position P_{zc} of which is determined 110 as a function of the drift angle α, is configured to capture a region of the scene filmed by the image sensor on board the drone along a viewing direction parallel to the direction of flight 40 of the drone.

In other words, the viewing direction is oriented virtually (not mechanically) on the actual direction of flight of the means under the method according to the invention.

According to a second alternative, which can be combined with the first alternative, the zone Zc, the position P_{Zc} of which is determined 110 as a function of the drift angle α, and the zone obtained in the absence of drift of the drone have a non-zero intersection.

FIG. 2 is a schematic illustration of the direction of flight of the fixed-wing drone 14 without wind. Without wind, the direction of flight 40 and the longitudinal axis 42 of the fixed-wing drone 14 are parallel (i.e., the vectors representative of the direction of flight 40 and the longitudinal axis 42 of the drone are collinear).

The center of the zone obtained without drift of the drone is consequently positioned on these two directions 40 and 42, combined. According to the second alternative, the size of the zone is therefore optimized such that the zones determined with and without wind are not separate, which makes it possible to ensure visual continuity when the wind rises abruptly.

According to a third alternative, the position P_{Zc} of the zone Zc is calculated such that the window corresponding to the overall field of the camera rotates 112, relative to that without drift, by a drift angle α of the drone around the yaw axis 48 of the drone.

Such a rotation of the center of the window corresponding to the zone Zc amounts to a translation and/or rotation of the zone Zc on the image sensor.

In other words, the window corresponding to the zone Zc is dynamically and virtually moved in the field of the camera produced by the image sensor 28.

Once the position P_{Zc} is determined as a function of the drift angle α, it is possible for the zone Zc to abut with the image sensor 28. In this case, according to a first alternative, the image corresponding to the zone Zc comprises a first black area, or according to a second alternative, the position P_{Zc} is reset such that the center of the zone Zc is on the longitudinal axis 42 of the fixed-wing drone 14. According to one particular embodiment, the image acquisition step 108 comprises acquiring 114 image data from the entire image sensor, followed by digital processing 116 of the image data delivering video images corresponding solely to the zone Zc.

In other words, according to this embodiment, the digital processing is done after the capture of the image data. Such digital processing makes it possible to shift, in time, the obtaining of corrected images to be played back to the user.

According to another specific embodiment, the image acquisition step 108 comprises the acquisition 118 of image data only in the zone Zc during the production of the video, the position P_{Zc} of the zone Zc being determined during the production of the video.

In other words, according to this other embodiment, the selection of the zone Zc is implemented in real time and is made subject in real time to the drift of the fixed-wing drone 14.

The method for capturing a video according to the invention makes it possible to optimize the piloting of the drone owing to the fact that the position of the zone Zc is made subject to the drift of the fixed-wing drone 14 caused by a cross wind.

The user 12 perceives, in particular via the use of the virtual-reality viewing system 10, the actual direction of the flight of the fixed-wing drone 14, even in case of drift thereof, since the video capture method according to the invention seeks to guarantee that the viewing direction of the image sensor and the direction of flight of the drone are parallel.

The method for capturing a video according to the invention consequently makes it possible to improve the ergonomics of the first-person view (FPV).

“The user experience” in the immersive piloting configuration therefore allows the user 12 to optimize the piloting, in order to account for the drift of the fixed-wing drone resulting from the force of the cross wind, to effectively reach the desired flight destination.

This further makes it possible to avoid the crash or deterioration of the fixed-wing drone in the presence of obstacles along the direction of flight resulting from the drift and not visible if the viewing direction of the image sensor points along the longitudinal direction of the fixed-wing drone 14.

1. A method for capturing a video using a camera on board a fixed-wing drone, the camera comprising an image sensor, the drone having, during flight, a drift angle between the longitudinal axis of the drone and a flight direction of the drone, the method comprising:
determining the drift angle of the drone; and
obtaining video by image acquisition corresponding to a zone with reduced dimensions relative to those of the image sensor, the position of the zone being determined as a function of the drift angle of the drone.

2. The method according to claim 1, wherein the camera comprises a fisheye lens associated with the image sensor.

3. The method according to claim 1, wherein the zone, the position of which is determined as a function of the drift angle, is configured to capture a region of the scene filmed by the image sensor on board the drone along a viewing direction parallel to the direction of flight of the drone.

4. The method according to claim 1, wherein the zone, the position of which is determined as a function of the drift angle, and the zone obtained in the absence of drift of the drone have a non-zero intersection.

5. The method according to claim 1, wherein the position of the zone is calculated such that the window corresponding to the overall field of the camera rotates, relative to that without drift, by a drift angle of the drone around the yaw axis of the drone.

6. The method according to claim 1, wherein the determination of the drift angle comprises:
the determination of the angle between the longitudinal axis of the drone and magnetic north,
the determination of the drift angle as a function of:
the angle between the longitudinal axis of the drone and magnetic north, and
the direction of flight of the drone.

7. The method according to claim 1, wherein obtaining video comprises acquiring image data from the entire surface area of the image sensor, followed by digital processing of the image data delivering video images corresponding solely to the zone.

8. The method according to claim 1, comprising the acquisition of image data only in the zone during the production of the video, the position of the zone being determined during the production of the video.

9. The method according to claim 1, wherein when the zone, the position of which is determined as a function of the drift angle, abuts with the image sensor, the image corresponding to the zone comprises a black area.

10. The method according to claim 1, wherein when the zone , the position of which is determined as a function of the drift angle, abuts with the image sensor, the position is reset such that the center of the zone is on the longitudinal axis of the fixed-wing drone.

11. A computer program product comprising software instructions for implementing a method according to claim 1 when it is executed on a computer.

12. An electronic system for capturing a video comprising a fixed-wing drone and a camera on board the drone, the camera comprising an image sensor, the drone having, during flight, a drift angle between a longitudinal axis of the drone and a flight direction of the drone,
wherein the electronic video capture system further comprises:
a determining module configured to determine the drift angle of the drone; and
an obtaining module configured to obtain the video by acquiring at least one image corresponding to a zone with reduced dimensions relative to those of the image sensor, the obtaining module being configured to determine the position of the zone as a function of the drift angle of the drone.
